(19) United States
(12) Patent Application Publication
(10) Pub. No.: US 2004/0008372 A1
(43) Pub. Date: Jan. 15, 2004

(54) Image processing device, image processing method and image processing program

(75) Inventors: Masamichi Akashi, Chiba (JP); Hiroshi Matsuda, Kanagawa (JP)

Correspondence Address: HOGAN & HARTSON L.L.P., 500 S. GRAND AVENUE, SUITE 1900, LOS ANGELES, CA, 90071-2611, US

(73) Assignee: CANON KABUSHIKI KAISHA

(21) Appl. No.: 10/611,213

(22) Filed: Jun. 30, 2003

(30) Foreign Application Priority Data
Jul. 11, 2002 (JP) 202390/2002(PAT.)
Feb. 28, 2003 (JP) 053266/2003(PAT.)

(51) Int. Cl. B41F 1/00; G06F 15/00; H04N 1/00

(52) U.S. Cl. 358/1.15; 358/402

(57) ABSTRACT

An image processing device that is capable of communicating with an external device that stores data is disclosed. The image processing device stores and manages data in a plurality of groups. The image processing device generates image data based on a data transmitted from a web browser on the external device, or image data based on a data obtained from a location designated by identification information, and stores the image data in a designated group.

### BACKGROUND OF THE INVENTION

1. Field of the Invention

The present invention relates to an image processing device that processes data stored in external devices, an image processing method that is performed in the image processing device, and a program to control the image processing method.

2. Related Background Art

Image forming devices represented by page printers and MFPs (multifunction peripherals) normally print based on PDL (Page Description Language) data generated by printer drivers.

In the meantime, as the WWW (World Wide Web) system has become widespread, various types of data have come to be exchanged on networks. Data exchanged on the WWW system are not limited to PDL data and include many types of data, such as HTML (Hypertext Markup Language) data, image files in GIF and JPEG formats, electronic document files in PDF (Portable Document Format) and SVG (Scalable Vector Graphics), and data files unique to application programs of host computers.

In view of this situation, a pull print system, in which an image forming device downloads document data indicated by a designated URL (Uniform Resource Locator) via network and prints based on the document data obtained, has been devised.

Additionally, a Web browser print system, in which a Web browser uses IPP (Internet Printing Protocol) or HTTP to send document data to an image forming device and the image forming device interprets and prints the document data, has also been devised.

With the pull print system, when a user wishes to print based on document data previously printed an image forming device must re-obtain the document data from a designated URL. With the Web browser print system, when a user wishes to print based on document data previously printed the user must re-send document data using the Web browser. Consequently, if the communications speed in a network is slow, it could take a long time for an image forming device to obtain document data, which results in a longer time to print. As a result, it is desirable for the number of times the image forming device re-obtains the same document data to be fewer.

If a plurality of users shares an image forming device or when one user inputs a plurality of URLs into an image forming device, document data or image data that correspond to a plurality of URLs would be stored in the image forming device. This makes it difficult for the user or users to determine which document data was the data desired.

Furthermore, a user must separately manage document data obtained through URLs, image data read by a scanner, and PDL data generated by a printer driver, which makes document control difficult. It would therefore be desirable for documents based on such different types of data to be managed in a consolidated manner.

In addition, when an image forming device obtains document data based on a URL and once the image forming device stores the document data, a user could obtain only the document based on that particular document data. In other words, even if the document data indicated by a URL were such that its contents were revised periodically, the document based on the contents when the document data was first obtained is the only document that could be outputted.

### SUMMARY OF THE INVENTION

Consequently, in accordance with an embodiment of the present invention, when a user wishes a document to be printed at high-speed based on the same document data every time, the step to obtain the document data can be omitted by storing the document data corresponding to the URL; on the other hand, when the user wishes to print the latest document data every time through a simple operation, the latest document data can be obtained from the URL to print a document based on the latest document data by storing the URL itself.

Other features and advantages of the present invention will be apparatus from the following description taken in conjunction with the accompanying drawings in which like reference characters designate the same or similar parts throughout thereof.

### BRIEF DESCRIPTION OF THE DRAWINGS

FIG. 1 is a block diagram illustrating the overall structure of an image processing system in accordance with an embodiment of the present invention.

FIG. 2 is a block diagram of the software configuration of an image forming device in accordance with an embodiment of the present invention.

FIG. 3 is a block diagram illustrating the hardware configuration of the image forming device.

FIG. 4 is an exterior view of the image forming device.

FIG. 5 is a front view of an operation section 2012.

FIG. 6 is a block diagram illustrating the configuration of the operation section of the image forming device.

FIG. 7 is a flowchart of a processing that takes place between an information processing device and the image forming device.

FIG. 8 is a flowchart of a print processing that takes place between the information processing device and the image forming device.

FIG. 9 is a flowchart of a print processing that takes place between the information processing device and the image forming device.

FIG. 10 is a diagram of the top page of a remote UI.

FIG. 11 is a diagram of a direct print page.

FIG. 12 is a diagram of the direct print page.

FIG. 13 is a flowchart of a print processing based on image data stored in a box that takes place between the information processing device and the image forming device.

FIG. 14 is a diagram of a box page.

FIG. 15 is a diagram of a box content list page.

FIG. 16 is a diagram of a print setting page.

FIG. 17 is a diagram illustrating a print processing based on document data.

FIG. 18 is a flowchart of the flow of processing operation of an image forming device.

FIG. 19 is a diagram of an example of setting applicable to the image forming device.

### DESCRIPTION OF THE PREFERRED EMBODIMENTS

Embodiments of the present invention are described in detail below with reference to the accompanying drawings.

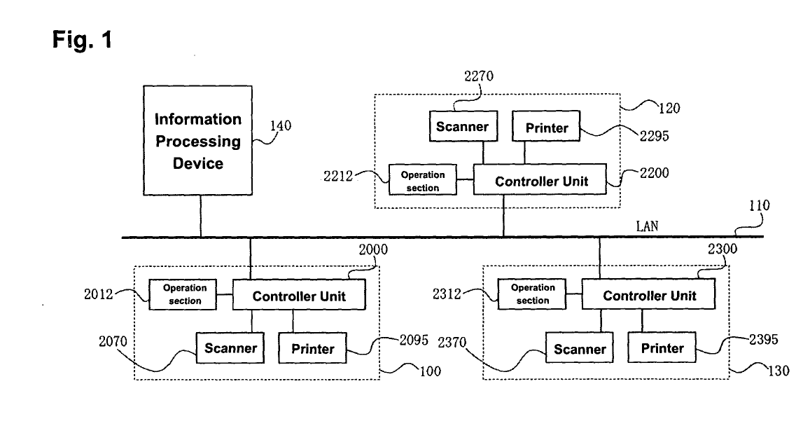

FIG. 1 is a block diagram illustrating the overall structure of an image processing system in accordance with an embodiment of the present invention. An image forming device 100 includes a scanner section 2070, which is an image input device; a printer section 2095, which is an image output device; a controller unit 2000; and an operation section 2012, which is a user interface. The scanner section 2070, the printer section 2095 and the operation section 2012 are each connected to the controller unit 2000, and the controller unit 2000 is connected to a network transmission means such as a LAN 110.

Other image forming devices 120 and 130, each of which has an equipment structure similar to that of the image forming device 100, are also connected to the LAN 110. The image forming devices 120 and 130 comprise scanner sections 2270, 2370; printer sections 2295, 2395; and operation sections 2212, 2312, respectively, and each section is connected to a respective controller unit 2200 or 2300.

In addition, an information processing device 140 such as a PC, workstation or information portable terminal is connected to the LAN 110. The information processing device 140 can operate as a Web client and can communicate with a Web server on the information processing devices.

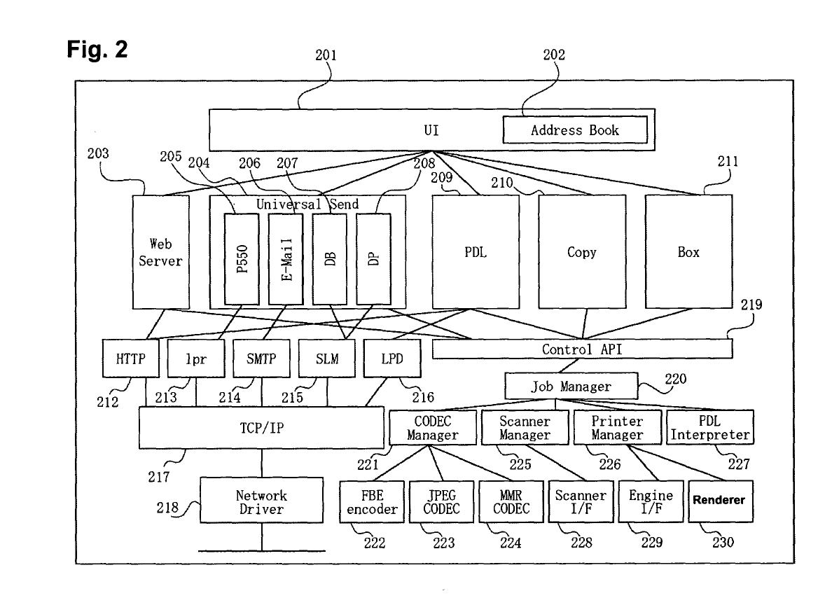

FIG. 2 is a block diagram of the software configuration of the image forming device. A UI module 201 governs the user interface with users and is a module that acts as an intermediary between an operator and equipment when the operator performs various operations and/or settings of the image forming device. The UI module 201 transfers input information to various other modules to request processing, or performs data setting, according to operations by the operator (user).

An address book module 202 is a database module that manages data transfer destinations and communications destinations. Data in the address book module 202 are added, deleted or obtained according to operations performed through the UI module 201 and sent to other modules as communications destination information based on the operator's operations.

A Web server 203 notifies management information of the image forming device based on requests from Web clients (e.g., Web browsers) outside the drawing.

A universal send module 204 is a module that governs data delivery. The universal send module 204 distributes data instructed by the operator through the UI module 201 to communications (output) destinations instructed. Additionally, when it is instructed by the operator to generate data using a scanner function of the image forming device, the universal send module 204 operates equipment via a controller API module 219, described later, to generate data.

A P550 module 205 is a module that is executed when a printer is designated as an output destination by the universal send module 204. A module 206 is executed when an e-mail address is designated as a communications destination by the universal send module 204. A module 207 is executed when a database is designated as an output destination by the universal send module 204. A module 208 is executed when another image forming device is designated as an output destination by the universal send module 204.

A PDL module 209 uses a print function of the image forming device to control print operations of PDL (Page Description Language) data sent from outside the image forming device. The PDL module 209 uses an HTTP module 212 to control print operations that take place based on document data obtained from external Web servers.

A copy module 210 uses the printer function and scanner function of the image forming device to control copy operations based on instructions from the UI module 201.

A box module 211 stores in boxes scanned image data inputted by the scanner function or raster image data generated by PDL data. A box function is a function that manages a plurality of data in units of groups, and a plurality of boxes is built in a storage space of an HDD 2004. Each set of image data is stored in a box designated by a user from among a plurality of boxes. The box module 211 controls the printing of the stored data through the printer function, the sending of the stored data through a universal send function, and the deleting of the stored data from the HDD 2004. It also provides management functions, such as grouping of data (i.e., storing data in individual boxes), moving data among boxes, and copying data among boxes.

A module 212 is used when the image forming device communicates through HTTP; it provides communications function to the PDL module 209 by using a TCP/IP module 217, described later.

An lpr module 213 provides communications functions to the P550 module 205 inside the universal send module 204 by using the TCP/IP module 217.

An SMTP module 214 provides communications functions to the e-mail module 206 inside the universal send module 204 by using the TCP/IP module 217.

An SLM (Salutation Manager) 215 provides communications functions to the database module 207 and the DP module 208 inside the universal send module 204 by using the TCP/IP module 217.

An LPD module 216 provides communications functions to the PDL module 209 by using the TCP/IP module 217.

The TCP/IP module 217 provides network communications functions to various modules by using a network driver, which will be described later.

A network driver 218 controls components physically connected to a network. The control API module 219 provides an interface to upper modules, e.g., the universal send module 204, the PDL module 209, the copy module 210, the box module 211, with lower modules such as a job manager 220, which is be described later. This reduces dependent relationships between upper modules and lower modules and improves adaptability of each of the modules.

The job manager 220 interprets processing instructed by various modules via the controller API module 219, and issues instructions to various modules described later. The job manager 220 uniformly manages hardware processing that is executed within the image forming device.

A CODEC manager 221 manages and controls compression and decompression processing of data of the various processing instructed by the job manager 220.

An FBE encoder 222 compresses in the FBE format data read in scan processing executed by the job manager 220 and a scanner manager 225.

A JPEG-CODEC module 223 performs JPEG compression processing of data read and JPEG development processing of print data in scan processing executed by the job manager 220 and the scanner manager 225 and in print processing executed by a printer manager 226, respectively.

An MMR-CODEC module 224 performs MMR compression processing of data read and MMR decompression processing of print data in scan processing executed by the job manager 220 and the scanner manager 225 and in print processing executed by the printer manager 226, respectively.

The scanner manager 225 manages and controls scan processing instructed by the job manager 220. A scanner I/F 228 provides an interface between the scanner manager 225 and a scanner section.

The printer manager 226 manages and controls print processing instructed by the job manager 220. An engine I/F 229 provides an interface between the printer manager 226 and a printer section.

A PDL interpreter 227 interprets PDL data or data in electronic document format and generates a display list according to an instruction by the job manager 220. The display list is in a common expression format that is independent of data type, whether the PDL or electronic document data.

A renderer 230, based on an instruction from the printer manager 226, develops the display list generated by the PDL interpreter 227 into raster image data on a raster image memory using an image processor.

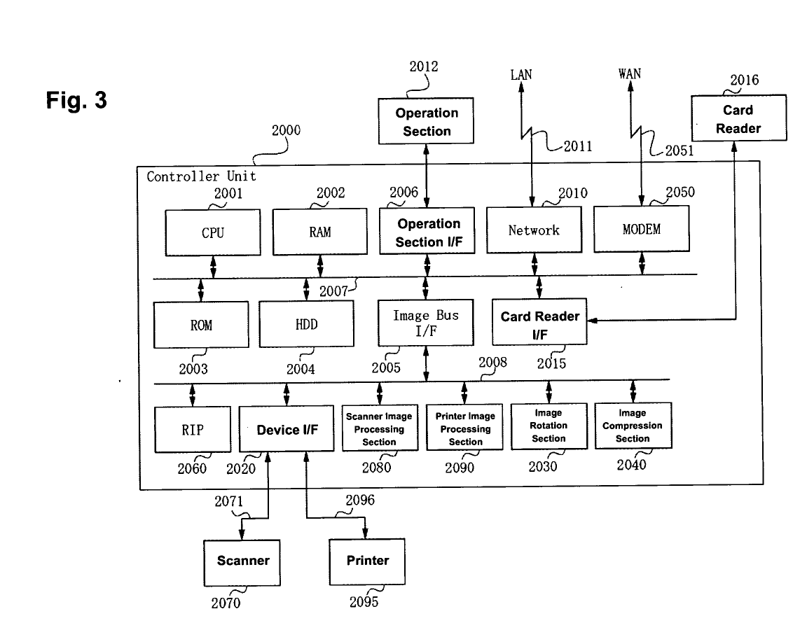

FIG. 3 is a block diagram illustrating the hardware configuration of the image forming device 100. The control unit 2000 is a controller that performs input/output of image information and device information by being connected on one hand to the scanner 2070, which is an image input device, and the printer 2095, which is an image output device, and on the other hand to the LAN 110 and/or a public telephone line (WAN; wide area network) 2051.

A CPU 2001 is a controller that controls the system as a whole. A RAM 2002 is a system work memory that allows the CPU 2001 to operate, as well as an image memory to temporarily store image data. A ROM 2003 is a boot ROM and stores the system's boot programs. An HDD 2004 is a hard disk drive that stores system software and image data.

An operation section I/F 2006 is an interface section with the operation section (UI) 2012 and outputs to the operation section 2012 the image data to be displayed on the operation section 2012. The operation section I/F 2006 also sends information inputted by a user through the operation section 2012 to the CPU 2001.

A network 2010 is connected to the LAN 110 and inputs and outputs information. A modem 2050 is connected to the public telephone line 2051 and inputs and outputs information.

The devices described are connected to a system bus 2007. An image bus I/F 2005 is a bus bridge that connects the system bus 2007 with an image bus 2008, which transfers image data at high-speed, and that converts data structure. The image bus 2008 consists of a PCI bus or IEEE 1394. The following devices are connected to the image bus 2008:

An image processor (RIP) 2060 develops display lists into raster image data. A device I/F section 2020 connects the scanner 2070 and the printer 2095, which are image input/output devices, with the controller 2000 and performs synchronous/asynchronous conversion of image data.

A scanner image processing section 2080 corrects, processes and edits input image data. A printer image processing section 2090 performs corrections, resolution conversions and half toning by the printer on print output image data.

An image rotation section 2030 rotates image data. An image compression section 2040 performs a JPEG compression/decompression processing on multivalue image data and JBIG, MMR or MH compression/decompression processing on binary image data. A card reader I/F 2015 is an interface section of a card reader 2016, which is a magnetic card reading device.

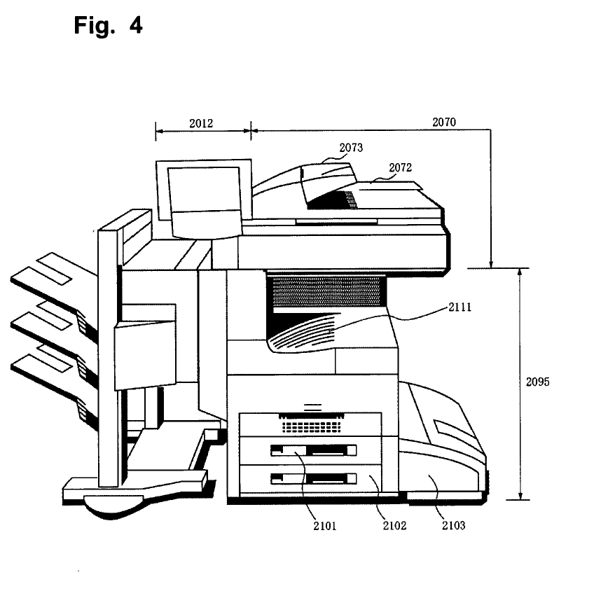

FIG. 4 is an exterior view of the image forming device 100. The scanner section 2070, which is an image input device, illuminates the image on a paper, which is the original, and scans the image with a CCD line sensor (not shown) to generate electric signals that are raster image data.

Original papers are set in a tray 2073 of an original feeder 2072; when a user instructs through the operation section 2012 to activate reading, the controller CPU 2001 issues an instruction 2071 to the scanner 2070, and the feeder 2072 feeds the original papers one page at a time to perform a read operation of images on the original.

The printer section 2095, which is an image output device, is a part that converts raster image data into images on papers; the conversion method may be the electrophotography method that uses a photosensitive drum or photosensitive belt, the inkjet method that discharges ink from a fine nozzle array directly on papers to print images, or any other method. The activation of print operation is triggered by an instruction 2096 from the controller CPU 2001. The printer section 2095 is provided with a plurality of paper feed stages to allow selection from among various paper sizes and/or various paper orientations, and paper cassettes 2101, 2102 and 2103 are provided to correspond to various selections. A paper delivery tray 2111 receives printed papers.

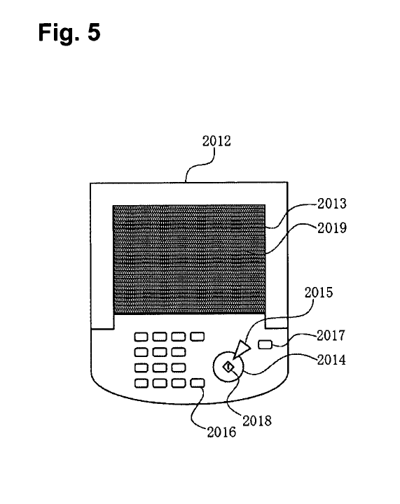

FIG. 5 is a diagram of the structure of the operation section 2012. On an LCD display section 2013 is affixed a touch panel sheet 2019, which allows the system's operations screen and soft keys to be displayed and, when any of the keys displayed is pressed, conveys its positional information to the controller CPU 2001.

A start key 2014 is used to begin a read operation of original images. At the center section of the start key 2014 is a green and red two-color LED 2018, and the color of the LED 2018 indicates the status of the start key 2014, i.e., whether it can be used. A stop key 2015 stops an operation in progress. An ID key 2016 is used to input a user's user ID. A reset key 2017 is used to initialize settings from the operation section 2012.

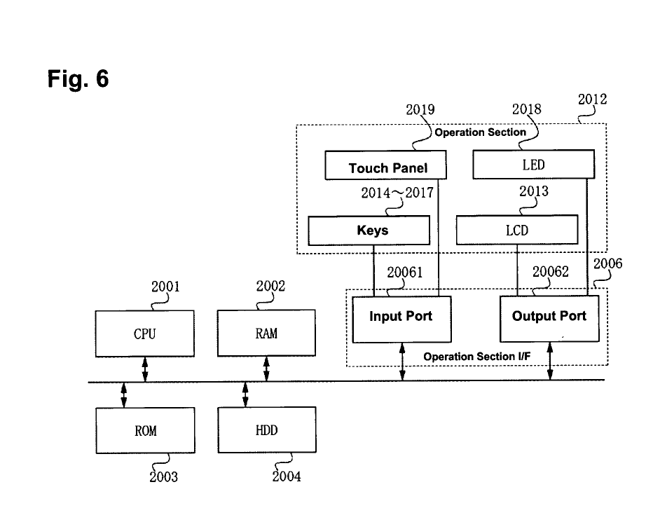

FIG. 6 is a block diagram illustrating the structure of the operation section 2012 of the image forming device 100. In the image forming device 100, the CPU 2001 comprehensively controls accesses to various devices connected to the system bus 2007 based on control programs stored on the program ROM 2003 and the HDD 2004, reads input information from the scanner 2070 connected via an image input section interface (which composes the device IF 2020), and outputs image signals as output information to the printer 2095 connected via a print section interface (which composes the device IF 2020). The RAM 2002 functions as the main memory and work area for the CPU 2001.

Furthermore, the CPU 2001 obtains via an input port 20061 of an operation section I/F 2006 operation contents inputted by a user through the touch panel 2019 or the hard keys 2014-2017. The CPU 2001 generates display image data based on the operation contents obtained and the control programs, and an output port (i.e., output device controller) 20062, which controls screen output devices, causes a screen output device 2013 such as an LCD or CRT to output the display screen based on the display image data.

As shown in FIG. 2, the Web server 203 operates within the image forming device 100. This makes HTTP-based communication possible for the image forming device 100. The Web server 203 can operate CGI (Common Gateway Interface) programs according to requests from Web clients.

In the HDD 2004 in FIG. 3 are stored a group of template files of Web pages and a group of resource files. These are used in the remote UI. The resource files are HTML (Hypertext Markup Language) files and image files used for page displays. The template files are files referred to by CGI programs to create pages.

To access the image forming device 100, a user either inputs a URL or a URI (Uniform Resource Identifier) directly in the Web browser, or selects a link in which the desired URL or URI is embedded. A URL is used in the following example:

A Web browser sends an HTTP command that designates a URL inputted by a user. The Web server 203 receives the HTTP command, analyzes the HTTP command, and performs operations accordingly.

If the request from the Web browser is not a request to activate a CGI program, a resource designated from among the group of resource files is sent to the Web browser and the processing is terminated.

If the request from the Web browser is a request to activate a CGI program, the corresponding CGI program is activated. Since CGI programs can receive query parameters when activated, a value designated by the user in the Web browser is transferred to the CGI program activated. The CGI program requests other modules to perform such operations as obtaining and/or setting device information and outputting print according to the request.

Furthermore, the CGI program uses a template file corresponding to a Web page and creates Web pages to be sent. Template files contain a part whose description changes depending on the information obtained, and this makes it possible to create Web pages whose contents change based on the information obtained.

The Web browser indicates to the user the Web page sent back from the image forming device 100. By using the Web browser to access the image forming device 100, the user can obtain and set functions, status and storage information of the image forming device 100 from outside the image forming device 100 and can remotely operate the image forming device 100. This function is called a remote UI.

Information that can be obtained and/or set through the remote UI includes, for example, device information that indicates paper sizes that can be used and the amount of paper left, designated job information, document data and/or image data stored in a storage device, e-mail and/or fax address information, and setting information regarding network.

Among operations that can be performed through the remote UI are printing and sending of document data and/or image data held in the image forming device 100 and printing of PDL data and/or electronic document data sent accompanying form data from Web browsers.

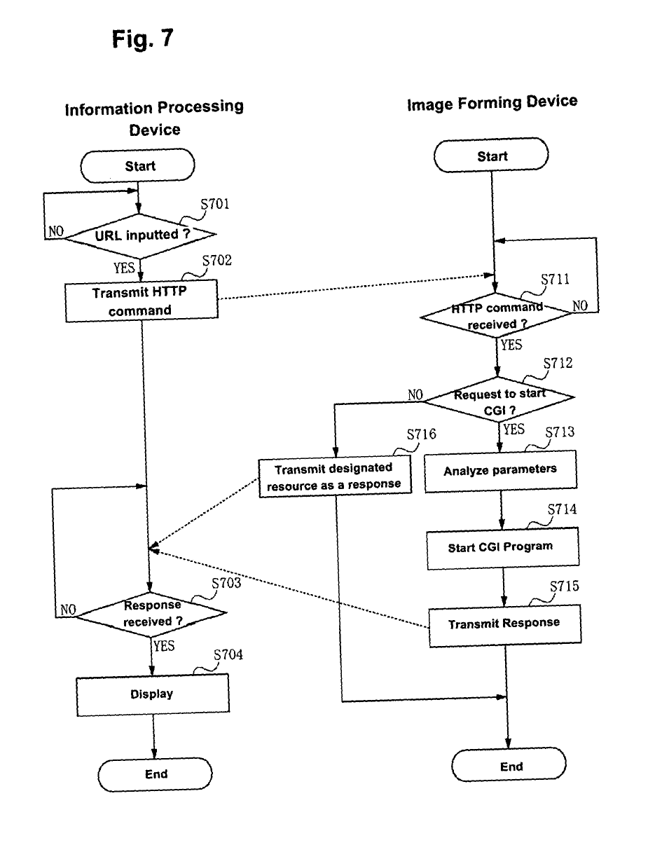

FIG. 7 is a flowchart of a processing that takes place between the information processing device and the image processing device. The flowchart indicates the processing that takes place when an HTTP command is sent from a Web browser to the Web server 203.

First, the Web browser activated in the information processing device determines whether a URL has been inputted by a user (step S701). If a URL has been inputted, the Web browser sends to the image forming device an HTTP command that includes the URL inputted (step S702).

Next, the information processing device waits for a response from the image forming device and determines if a response has been received (step S703). If a response has been received, the content of the response received is displayed; for example, if data described in HTML (HTML data) is received, the HTML data is analyzed and a display based on the HTML data takes place.

In the image forming device in the meantime, the Web server 203 of the image forming device determines whether an HTTP command has been received (step S711). If an HTTP command has been received, the Web server 203 determines whether the HTTP command is a request to activate CGI (step S712).

If the HTTP command is a request to activate CGI, the Web server 203 analyzes CGI parameters (S713) and activates a CGI program (step S714). If a response to the Web browser is required due to processing by the CGI program, required data is sent as the response to the information processing device (step S715). On many Web pages, the display content changes based on the status. As a result, the activated CGI program obtains information regarding the image forming device, composites the information obtained with a template file to generate HTML data, and sends back the HTML data as the response.

In the meantime, if the HTTP command is not a request to activate CGI, a resource designated in the HTTP command is sent as a response (step S716). If the designated resource is HTML data, no processing is performed on the HTML data and the HTML data designated is sent back unaltered.

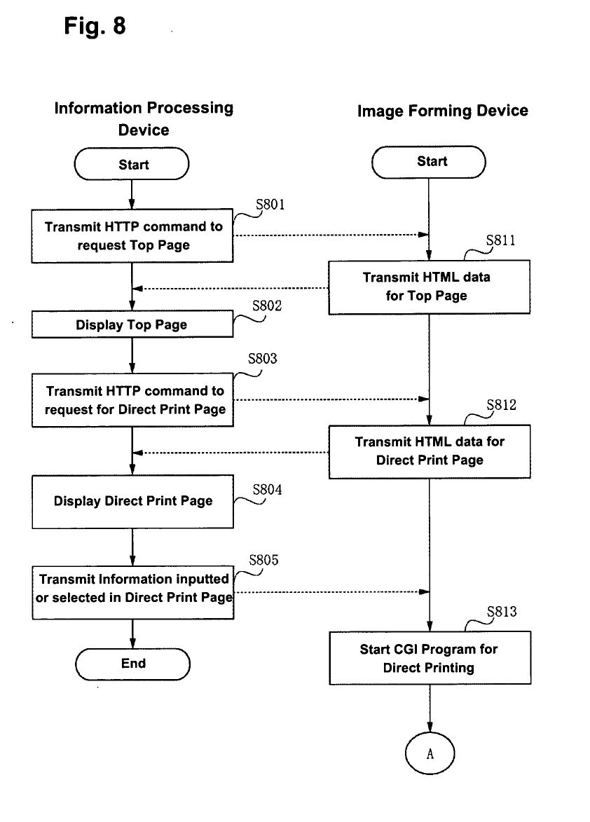

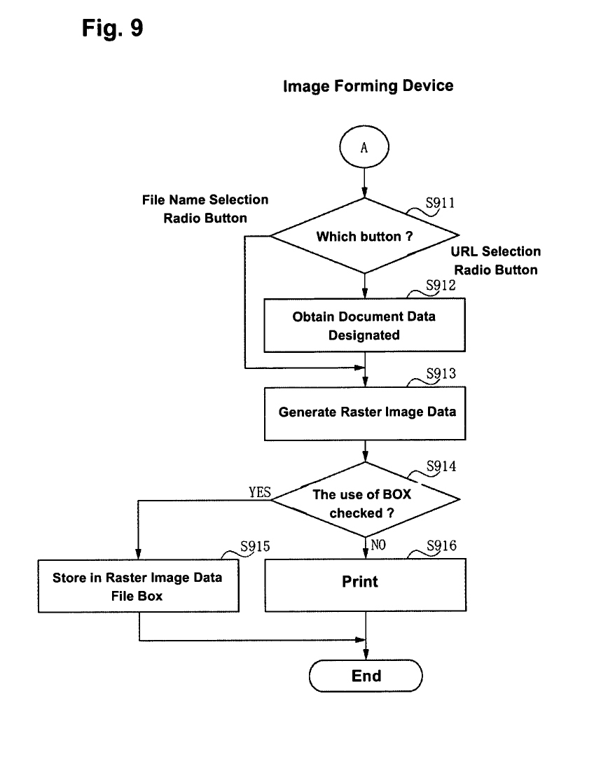

Next, we will describe a print processing that takes place between the information processing device and the image forming device. FIGS. 8 and 9 are a flowchart of the print processing.

First, when a user inputs a URL indicating the top page of a remote UI into a Web browser, the Web browser sends to the image forming device an HTTP command that includes the URL (step S801). The Web server 203 sends to the information processing device HTML data for the top page of the remote URI (step S811). The Web browser receives the HTML data for the top page and displays the top page based on the HTML data (step S802).

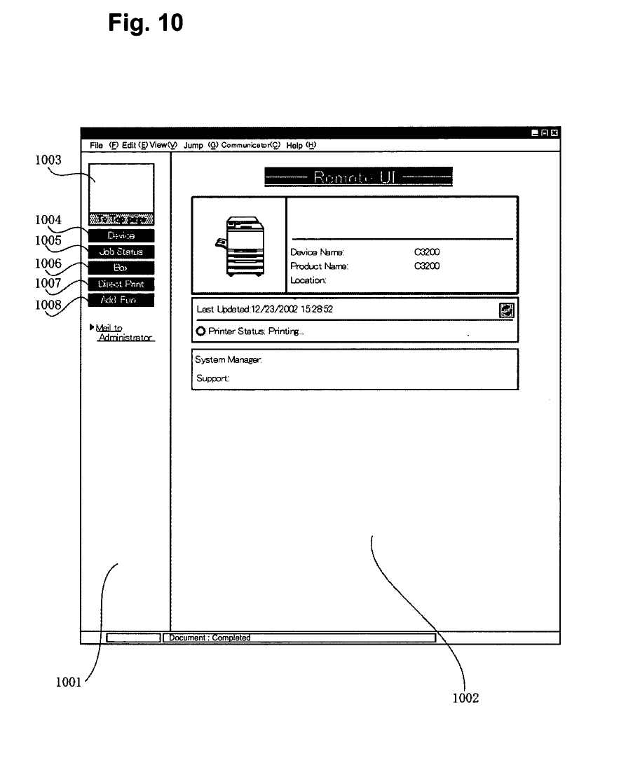

FIG. 10 is a diagram of the top page of a remote UI. The screen consists of two frames, one an index region 1001 and the other a main region 1002. The index region 1001 displays a main site map, and a screen that corresponds to a button pressed on the site map is displayed in the main region 1002.

The top page of the remote UI is a default page displayed when an IP (Internet Protocol) address of the image forming device is designated as a URL in the Web browser. The top page displays general information concerning the image forming device. When buttons arranged in the index region 1001 (a device button 1004, a job station button 1005, a box button 1006, a direct print button 1007 and a user mode button 1008) are pressed, a device information page, a job status page, a box page, a direct print page or a user mode page is displayed depending on the button pressed. Pressing a button 1003 to return to the top page displays the top page.

When a user selects the direct print button 1007 in the top page, the Web browser sends to the image forming device an HTTP command that includes a URL indicating a direct print page (step S803). The Web server 203 sends to the information processing device HTML data for the direct print page (step S812). The Web browser receives the HTML data for the direct print page and displays the direct print page based on the HTML data (step S804).

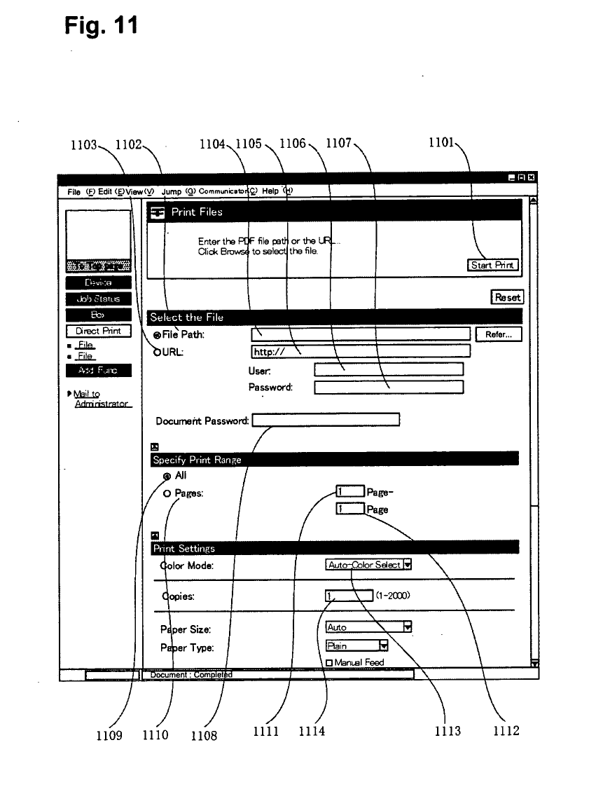

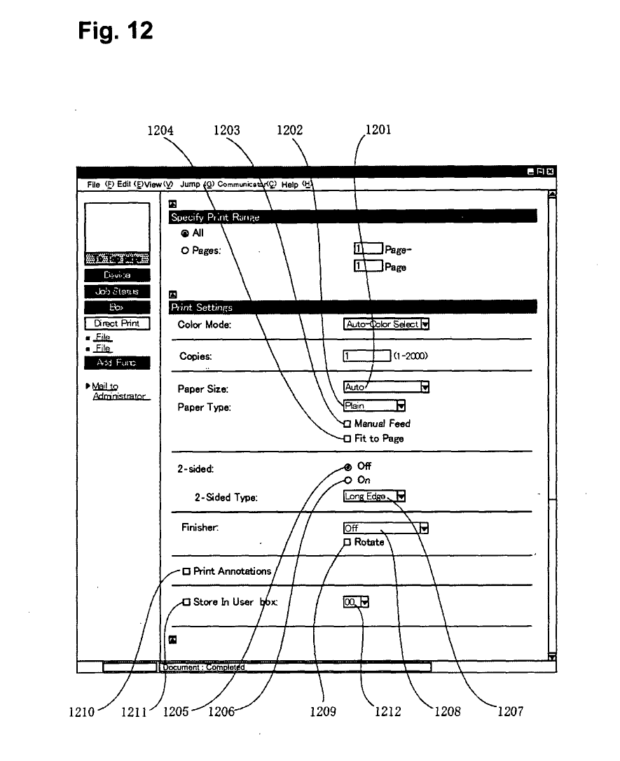

FIGS. 11 and 12 are diagrams indicating a direct print page. FIG. 12 is a continuation of the screen from FIG. 11. When the screen in FIG. 11 is scrolled down, the screen in FIG. 12 is displayed.

A filename selection radio button 1102 and a URL selection radio button 1103 are toggle buttons, and only one of them can be selected at any one time. When the filename selection radio button 1102 is selected, the document data indicated by a file path name inputted in a file path name input field 1104 becomes the subject of printing. If the URL selection radio button 1103 is selected, the document data indicated by a URL inputted in a URL input field 1105 becomes the subject of printing. The only protocol that can be inputted into the URL input field 1105 is HTTP.

If the document data indicated by the URL is managed by a Web server that requires verification, the user inputs his or her user name and password into a user name input field 1106 and a password input field 1107, respectively.

A start button 1101 is a button that instructs printing based on document data to be printed.

A document password input field 1108 is used for inputting a document password required for decoding document data if the document data to be printed is encrypted.

An all page designation radio button 1109 and a page range designation radio button 1110 are toggle buttons. By selecting one or the other, the user can designate whether to print all pages or only certain pages of the document data to be printed. If the page range designation radio button 1110 is selected, pages beginning with the page designated in a print beginning page designation field 1111 to the page designated in a print end page designation field 1112 are printed.

When the user presses a color mode setting pull-down 1113, a pull-down menu with two choices of automatic color mode and black-and-white mode is displayed, and the user can select one or the other. If the automatic color mode is selected, color output or black-and-white output takes place depending on the content of document data; if the black-and-white mode is selected, black-and-white output takes place regardless of the content of the document data, even if the document data contains chromatic colors.

The number of print copies is inputted in a print copy designation field 1114. When the user presses a page size designation pull-down 1201, a pull-down menu that includes automatic paper size and various standard paper sizes as choices is displayed, and the user can select one of the print paper sizes. If the automatic paper size is selected, a print paper is selected according to the size of each page designated for printing in the document data.

When the user presses a paper type designation pull-down 1202, a pull-down menu that includes various paper types as choices is displayed, and the user can select one of the print paper types. If a manual feed designation check box 1203 is checked, manual feed of paper takes place; if a fit to page check box 1204 is checked, each page in the document data is printed to fit the paper size designated in the paper size designation pull-down 1201.

If the user checks a check box for any function, it signifies that the user has designated that particular function.

A two-sided off radio button 1205 and a two-sided on radio button 1206 composes toggle buttons, and the user can designate whether or not to print on two sides of papers by selecting one of the buttons. If the two-sided on radio button 1206 is selected, which edge to flip on can be designated in a two-sided type pull-down 1207.

When the user presses a finishing type designation pull-down 1208, a pull-down menu that includes various finishing designations as choices is displayed, and the user can select one of the finishing. If a rotation sort designation check box 1209 is checked, a rotating sort is performed.

If a print annotation check box 1210 is checked, annotations contained in the document data are printed.

If a box storage designation check box 1211 is checked, the image forming device develops the document data obtained to generate raster image data and, instead of printing based on the raster image data, stores the raster image in a box on the HDD 2004. The raster image data is stored in a box designated in a box number designation pull-down 1212.

When the user presses the print start button 1101, the Web browser sends to the image forming device an HTTP command that includes information inputted or selected in the direct print page (step S805). If the filename selection radio button 1102 is selected, the document data indicated by the file path name inputted in the file path name input field 1104 is multi-part encoded and sent to the image forming device.

In the meantime, the image forming device starts a CGI program for direct printing in response to the HTTP command (step S813). The CGI program for direct printing determines which of the filename selection radio button 1102 and the URL selection radio button 1103 has been selected (step S911). If it determines that the URL selection radio button 1103 is the one selected, the document data indicated by the URL inputted in the URL input field 1105 is obtained from an external device (for example, an external database or other Web server devices) via a network (step S912).

The document information sent in step S805 or the document data obtained in step S912, along with information set in the direct print page, are sent to the PDL interpreter 227 via the control API 219 and the job manager 220, and the PDL interpreter 227 develops the document data and generates raster image data (step S913).

Next, the Web server 203 determines whether the box storage designation check box 1211 is checked (step S914). If the box storage designation check box 1211 is checked, the raster image data generated is stored in a box designated in the box number designation pull-down 1212 (step S915).

If the box storage designation check box 1211 is not checked, the printer 2095 prints on papers images based on the raster image data (step S916).

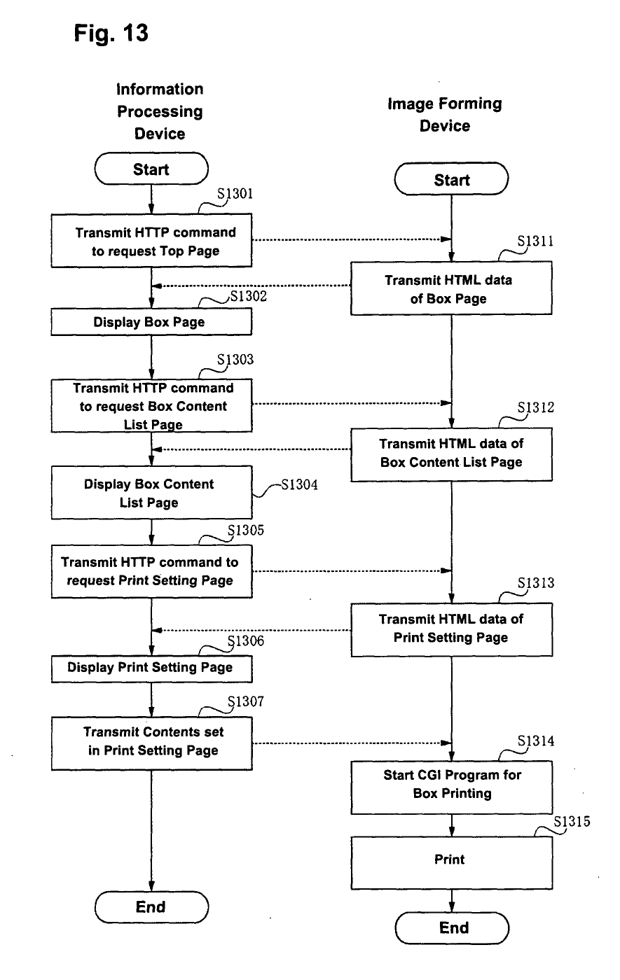

Next, we will describe a print processing that is based on image data stored in a box and that takes place between the information processing device and the image forming device. FIG. 13 is a flowchart of the print processing.

When the user presses the box button 1006, the Web browser sends to the image forming device an HTTP command that includes a URL indicating a box page (step S1301). The Web server 203 sends to the information processing device HTML data for the box page (step S1311). The Web browser receives the HTML data for the box page and displays the box page based on the HTML data (step S1302).

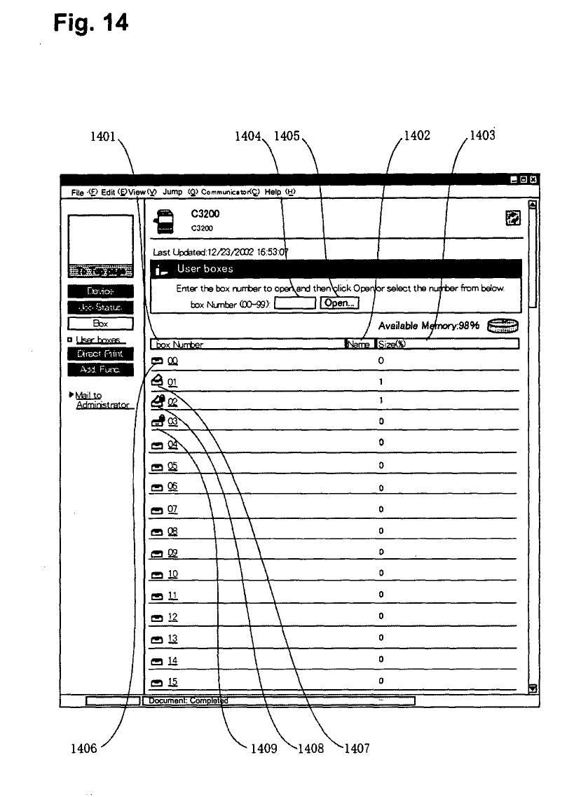

FIG. 14 is a diagram of a box page. In the box page, a list of boxes that are currently in the image forming device is displayed in the main region. For each box, a box number 1401, a box name 1402 and a storage region use rate by data in the box 1403 are displayed as one record. The storage region use rate is the ratio occupied by the data in the corresponding box within an HDD region allocated for boxes.

An icon to the left of each box number 1401 indicates the status of the box (i.e., whether it contains data and whether a password is set). An icon 1407 indicates that there are data in the corresponding box and that a password is not set. An icon 1408 indicates that there are data in the corresponding box and that a password is set. An icon 1409 indicates that there are no data in the corresponding box and that a password is set.

Each of the box numbers 1401 is a link text. When the user selects a link text in the Web browser, the Web browser sends to the image forming device an HTTP command that includes a URL or a box number that corresponds to the link text (step S1303). The Web server 203 sends to the information processing device HTML data for a box content list page that corresponds to the box number designated or HTML data for a box content list page indicated by the URL designated (step S1312). The Web browser receives the HTML data for the box content list page and displays the box content list page based on the HTML data (step S1304).

When a link text of a box number with a password is selected, a dialog box (not shown) that urges the user to input the password is displayed in the Web browser. The box content list page is displayed only when the password is inputted into the dialog box and verified.

The box content list page can also be displayed when the user inputs a box number in a text input field 1404 and presses a button 1405. If there is a password set for the box selected, the password must be verified.

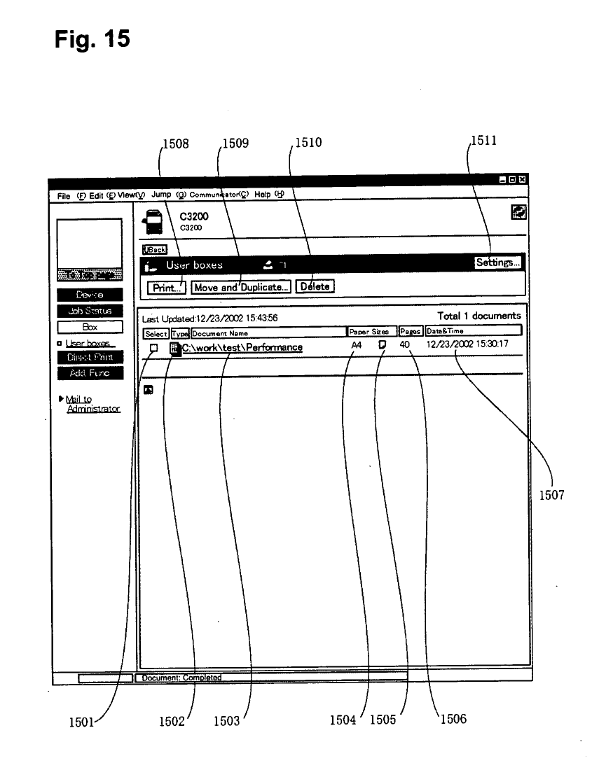

FIG. 15 is a diagram of a box content list page. In the box content list page, a list of document images that are in the designated box is displayed in the main region. Each document image is a collection of raster image data for a plurality of pages; normally, a plurality of scanned image data collectively and consecutively read through a scanner or a plurality of raster image data generated from document data or PDL data constitutes one document image. However, there may be document data images each comprising image data for one page.

For each document image, a selection check box 1501, a document image bitmap 1502, a document image name 1503, a document image size 1504, a document image orientation icon 1505, a document image page number 1506 and date and time the document image was created 1507 are displayed as one record.

When a print button 1508 is pressed, a print setting page is displayed and the user can instruct printing. When a move button 1509 is pressed, a document moving page is displayed and the user can instruct a document to be moved between boxes. When a delete button 1510 is pressed, the document image selected is deleted from the corresponding box. In printing, moving and deleting, the document image checked in the selection check box is the subject of instruction. When a setting button 1511 is pressed, a setting/registration page (not shown) for the corresponding box is displayed. In the setting/registration page for the user box, the user can set names, passwords, and automatic erasure time for document images (i.e., a function that automatically deletes a document image after the time set has passed) for the boxes.

When the user presses the print button 1508, the Web browser sends to the image forming device an HTTP command to request a print setting page (step S1305). The Web server 203 sends to the information processing device HTML data for the print setting page (step S1313). The Web browser receives the HTML data for the print setting page and displays the print setting page based on the HTML data (step S1306).

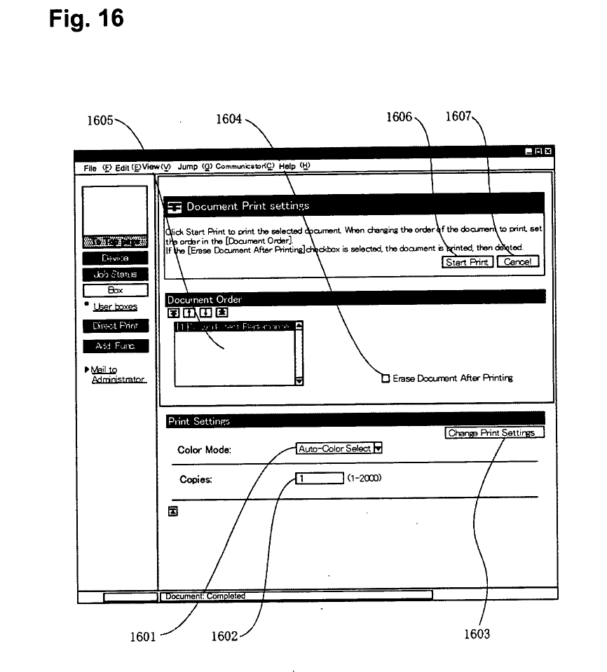

FIG. 16 is a diagram of a print setting page. When the user presses a color mode setting pull-down 1601, a pull-down menu that includes automatic color and black-and-white as two choices is displayed, and the user can select one of the color modes. The automatic color mode automatically determines whether image data is color image data and prints accordingly, while the black-and-white mode outputs in black-and-white regardless of whether the image data itself is black-and-white or color.

The user inputs a number of print copies in a print copy number setting input field 1602. When the user presses a change print setting button 1603, a change print setting page (not shown) is displayed and the user can set advanced settings such as two-sided printing and finishing.

When an erase document after printing check box 1604 is checked, the corresponding document image is erased after printing is completed. The user can designate the order of printing a plurality of document images using a print order designation list 1605. When a cancel button 1607 is pressed, settings for the print setting page are invalidated and the box content list page is displayed again.

When the user presses a print start button 1606, the Web browser sends to the image forming device the content set in a print setting page (step S1307). The Web server 203 activates a CGI program for box printing (step S1314). A box print instruction command, a box number and a document image ID that correspond to the content of the print setting page are sent to the printer manager 226 from the CGI program for box printing via the control API 219 and the job manager 220. The printer manager 226 takes out from the HDD 2004 image data for the document image designated, and the printer 2095 prints on paper the image based on the image data (step S1315).

By storing raster image data in a box, processing to transfer document data and to develop document data becomes unnecessary, which can shorten the time required for printing.

When document data is downloaded from a designated URL and printed, there is a possibility that transferring document data could take a long time depending on the communications speed and congestion of the network or that transferring document data could fail. However, by storing raster image data in a box, the subsequent print processing takes place smoothly.

Furthermore, due to the fact that raster image data based on document data indicated by a designated URL, raster image data generated from PDL data, and scanned image data can be stored in the same box, the document control becomes easier for the user. For example, the user can quickly obtain a copy document and a document obtained via a network at the same time.

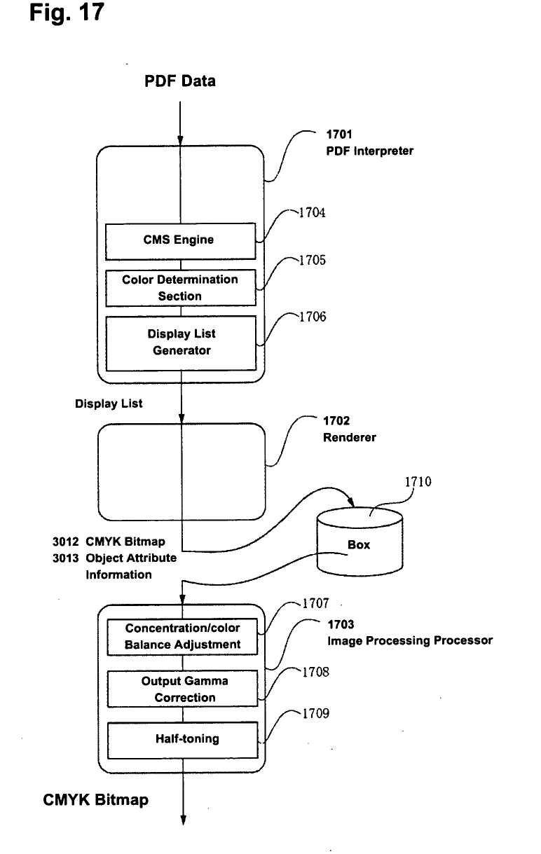

Next, we will describe the flow of a processing from the time raster image data is generated from document data and the raster image data generated is stored in the box, to the time printing takes place based on the raster image data stored in the box. FIG. 17 is a diagram of this processing flow. In this example, the processing involves PDF (Portable Document Format) data as document data.

A PDF interpreter 1701 is a type of the PDL interpreter 227 in FIG. 2; the PDF interpreter 1701 interprets data described in PDF format and generates a display list as neutral language data.

A CMS engine 1704 is a module that performs color management and generates output colors (CMYK) unique to the corresponding printer engine after converting input colors into absolute color space. In PDF data, diverse color spaces, such as a device color space, CIEBased color space and special color space, are defined. Input colors designated by the device color space are color-converted using the designated ICC profile from among a group of ICC profiles prepared in advance, such as RGB source profile and CMYK simulation profile. Input colors designated by the CIEBased color space are color-converted according to a conversion table, a conversion function and a conversion matrix designated for the color space. The conversion from the absolute color space into a color space unique to a given printer engine is performed using an output profile. The output profile can be selected from a gray compensation profile, in which priority is placed on having the gray scale expressed in one color K, and a normal profile that expresses the gray scale in four colors of CMYK.

A color determination section 1705 checks the CMYK colors that are output values of the CMS engine 1704 and determines whether the page currently being processed is a color page or a black-and-white page. A display list generator 1706 generates display lists, which are intermediate language data. Each display list contains an attribute flag for each object, and this identifies each object as graphics, image or character. The attribute flags are processed in a renderer 1702 and used in an image processing processor 1703, which is a succeeding stage to the renderer 1702.

The renderer 1702 interprets the display list and generates CMYK bitmaps, each of which is made up of an 8-bit depth×4 colors, and uses the RIP 2060 in FIG. 3 to perform majority of the processing. Based on the attribute flags included in the display list, the renderer 1702 also generates as the fifth information an object attribute map that indicates attributes on a device pixel-by-device pixel basis. Each object attribute map has attribute information of a 2-bit depth (e.g., graphics=01, image=10, character=11) for each pixel.

When storing in a box is instructed, the printer manager 226 stores in a partition designated in a box 1710 CMYK bitmaps 3012 and an object attribute map 3013 generated, and terminates the job.

When a print instruction for a document in a box is sent to the printer manager 226 from the CGI program for box printing via the control API 219 and the job manager 220, the printer manager 226 takes out the CMYK bitmaps and the object attribute map stored in a box 1710 and sends them to the image processing processor 1703.

The image processing processor 1703 is controlled by the printer manager 226 and performs image processing, such as a concentration/color balance adjustment 1707, an output gamma correction 1708 and a half-toning 1709, on the CMYK bitmaps generated by the renderer 1702.

The half-toning 1709 refers to the object attribute map to apply a different half-toning to each object attribute. For example, the half-toning 1709 applies a screen with high number of lines that places priority on resolution to image regions with graphics attributes, a low resolution screen that places priority on gray scale to image regions with image attributes, and error diffusion to image regions with character attributes.

If a page is determined to be a black-and-white page by the color determination section 1705, only the bitmap for K of the CMYK bitmaps created by the renderer 1702 is sent to the image processing processor 1703, and a K bitmap to be used in the final output is generated. On the other hand, if a page is determined to be a color page by the color determination section 1705, the CMYK bitmaps generated by the renderer 1702 are sent unaltered to the image processing processor 1703, and CMYK bitmaps to be used in the final output are generated.

In this way, the CMYK bitmaps or the K bitmap generated by the image processing processor 1703 are transferred to a printer engine via the engine I/F 229 in FIG. 2 and printed on a desired medium.

According to the embodiment, the raster image data generated from PDL data and raster image data generated from document data are stored in a box. As a result, the time it takes from the time the start button 1606 in the print setting page is pressed to the time printing takes place on a paper is further shortened. However, when a higher priority is placed on saving consumption of storage capacity of the image forming device, the PDL data and document data may be stored in a box. This can save the consumption of storage capacity of the image forming device.

Data formats of a plurality of data stored in a box may be different.

A URL inputted through the URL selection radio button 1103 can be stored in a box. In this case, after the start button 1606 in the print setting page is pressed, the image forming device obtains the document data indicated by the URL stored in the box via the network. Raster image data is then generated from the document data obtained, and images based on the raster image data are printed on paper. This allows the latest content to be printed even when document data changes with time. This also further saves consumption of storage capacity.

In the following example, an image forming device is connected to a host computer and a plurality of print data servers via a network. The host computer sends to the image forming device information described as an address, such as a URL, indicating the location where print data to be printed is stored. The image forming device interprets the URL sent from the host computer, accesses one of the print data servers based on the URL, receives the print data from the print data server, and prints the print data as an output.

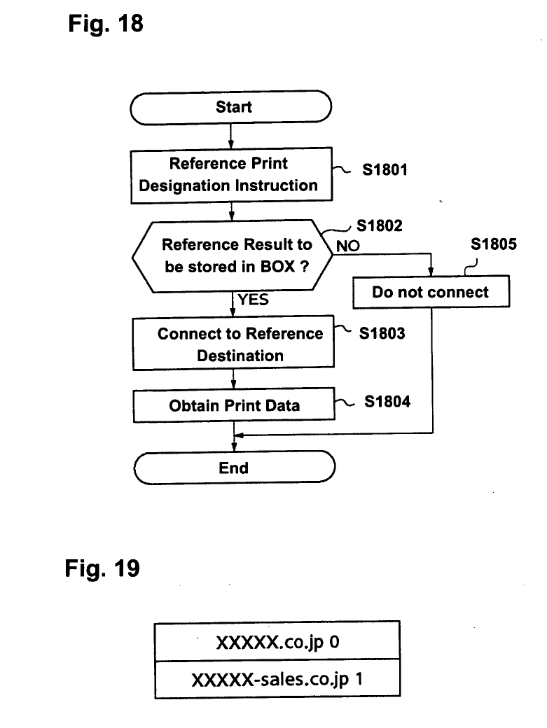

FIG. 18 is a flowchart of a process operation that takes place up to the time the image forming device connects to the print data server designated and obtains print data.

In FIG. 18, first in step S1801, the image forming device receives from the host computer a reference print designation instruction that includes a print data server URL. Next, in step S1802, the image forming device sets whether to store print data as a reference result in a box within the image forming device. If the print data is not to be stored in a box as a reference result, the processing proceeds to step S1805. In step S1805, the image forming device stores the URL as reference information in a box without connecting to a reference destination (i.e., a URL destination) and terminates the processing operation.

On the other hand, if the print data is determined in step S1802 to be stored in a box as a reference result, the processing proceeds to step S1803. In step S1803, the image forming device connects to a reference destination; in the next step S1804, the image forming device obtains the print data and terminates the processing operation.

Although a reference print designation instruction that includes a network-like address (URL) of the print data server is received from the host computer in step S1801, print data that includes the network-like address may instead be received. In the latter case, first, the image forming device determines whether the network-like address is included in the print data; if it is included, the image forming device executes the processing steps beginning with step S1802.

Although the setting of whether to store the print data as a reference result in a box can be set, the processing operation may be altered to allow the processing to proceed to step S1805 if print data could not be obtained for whatever reason even though an attempt was made to connect to the reference destination.

Although whether to store the print data as a reference result in a box can be set, a setting to store either the reference result or reference information depending on the domain of the reference destination can also be provided.

FIG. 19 is an example of a setting to make a determination as to whether a reference result is stored in a box depending on the domain of the reference destination. As shown in the figure, the reference result is not stored in a box if the domain is “xxxxx.co.jp” (where the value is 0) in the first line, and the reference result is stored in a box if the domain is “xxxxx-sales.co.jp” (where the value is 1) in the second line.

The setting for determining whether to store the reference result in a box can be made through the operation section 2012 or the host computer.

The image forming device can be a printer, copier, multifunctional equipment or facsimile machine.

The objective of the present invention can be achieved by supplying to a system or a device a storage medium (or a recording medium) that stores program codes of software that realize the functions of the embodiments described above, and by having a computer (or a CPU or an MPU) of the system or the device read and execute the program codes stored in the storage medium. In this case, the program codes themselves that are stored on the storage medium realize the functions of the embodiment described above, and the storage medium that stores the program codes constitutes the present invention. Furthermore, the present invention is applicable not only when the program codes read by a computer are executed to realize the functions of the embodiment, but also when an operating system (OS) that operates on the computer performs a part or all of the actual processing based on the instructions contained in the program codes and through the processing realizes the functions of the embodiment.

Moreover, the present invention is also applicable when the program codes that are read from the storage medium are written onto a memory provided on an expansion card inserted into a computer or on an expansion unit connected to a computer, and a CPU provided on the expansion card or the expansion unit performs a part or all of the actual processing based on the instructions contained in the program codes and through the processing realizes the functions of the embodiment.

According to the present invention, by storing in a designated group image data generated from data stored in external devices, processing to transfer data or to develop data becomes unnecessary, which can shorten the time required for processing.

When data is obtained based on designated identifying information and processed, there is a possibility that data transfer could take a long time depending on the communications speed and congestion or that data transfer could fail. However, by storing in a designated group data obtained or image data generated from the data, the subsequent processing takes place smoothly.

Furthermore, due to the fact that image data based on data stored in external devices, and image data generated from print data or image data read from an original, can be managed in the same group, the document control becomes easier for the user. For example, the user can quickly obtain a copy document and a document obtained via a network at the same time.

Consequently, when a user wishes to print at high-speed based on the same print data every time, the step to obtain the print data can be omitted by storing the print data corresponding to the reference destination; on the other hand, when the user wishes to print based on the latest print data every time through a simple operation, the latest print data can be obtained as necessary from the reference destination and printing can take place based on the latest print data by storing the reference information in a box.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An image processing device that is capable of communicating with an external device that stores data, the image processing device comprising:
a storage module that stores and manages data in a plurality of groups;
a receiving module that receives data transmitted from a web browser of the external device;
an image generation module that generates image data based on the data received by the receiving module; and
a control module that controls the image data generated by the image generation module such that the image data is stored in designated one of the groups.

2. An image processing device that is capable of communicating with an external device that stores data, the image processing device comprising:
a storage module that manages and stores data in a plurality of groups;
an input module that inputs identification information for identifying the data stored in the external device;
an obtaining module that obtains from the external apparatus the data corresponding to the identification information inputted by the input module;
an image forming module that generates image data based on the data obtained by the obtaining module; and
a control module that controls the image data generated by the image forming module such that the image data is stored in designated one of the groups.

3. An image processing device according to claim 2, wherein the storage module stores image data generated by the image forming module, and image data that is generated based on print data received from outside or is generated based on an image on a document in a common group.

4. An image processing device according to claim 3, further comprising a print data analysis module that analyzes the print data and generates raster image data based on the print data analyzed,
wherein the image forming module analyzes the data and generates raster image data based on the data.
the control module controls the raster image data generated by the image forming module and the raster image data generated by the print data analysis module such that both of the raster image data are stored in designated one of the group.

5. An image processing device according to claim 2, further comprising a print module that prints based on image data stored in the designated group among image data stored in the storage module.

6. An image processing device according to claim 2, further comprising a transmission module that transmits to an information processing device page data for displaying a screen for setting identification information on a web browser,
wherein the input module inputs the identification information set through the screen.

7. An image processing device that is capable of communicating with an external device that stores data, the image processing device comprising:
a reading module that reads an image on a document and generates image data corresponding to the image read;
a storage module that manages and stores image data generated based on print data received from outside or image data generated by the reading module in a plurality of groups;
an input module that inputs identification information for identifying the data stored in the external device;
an obtaining module that obtains from the external apparatus the data corresponding to the identification information inputted by the input module;
an image forming module that generates image data based on the data obtained by the obtaining module; and
a control module that controls the image data generated by the image forming module such that the image data is stored in designated one of the groups.

8. An image processing device that is capable of communicating with an external device that stores data, the image processing device comprising:
a reading module that reads an image on a document and generates image data corresponding to the image read;
a storage module that manages and stores print data received from outside, image data generated based on the print data or image data generated by the reading module in a plurality of groups;
an input module that inputs identification information for identifying the data stored in the external device;
an obtaining module that obtains from the external apparatus the data corresponding to the identification information inputted by the input module;
an image forming module that generates image data based on the data obtained by the obtaining module; and
a control module that controls such that the data obtained by the obtaining module or the image data generated by the image forming module is stored in designated one of the groups.

9. An image processing method performed by an image processing device that is capable of communicating with an external device that stores data and managing data in a plurality of groups, the image processing method comprising:
a receiving step of receiving data transmitted from a web browser of the external device;
an image generation step of generating image data based on the data received in the receiving step; and
a control step of controlling the image data generated in the image generation step such that the image data is stored in designated one of the groups.

10. An image processing method performed by an image processing device that is capable of communicating with an external device that stores data and managing data in a plurality of groups, the image processing method comprising:
an input step of inputting identification information for identifying the data stored in the external device;
an obtaining step of obtaining from the external apparatus the data corresponding to the identification information inputted in the input step;
an image forming step of generating image data based on the data obtained in the obtaining step; and
a control step of controlling the image data generated in the image forming step such that the image data is stored in designated one of the groups.

11. An image processing method according to claim 10, further comprising a print step of printing based on image data stored in the designated group among a plurality of groups.

12. An image processing method according to claim 10, further comprising a transmission step of transmitting to an information processing device page data for displaying a screen for setting identification information on a web browser,
wherein the input step inputs the identification information set through the screen.

13. An image processing method performed by an image processing device that is capable of communicating with an external device that stores data and managing print data received from outside, image data generated based on the print data or image data generated based on an image on a document, the image processing method comprising:
an input step of inputting identification information for identifying the data stored in the external device;
an obtaining step of obtaining from the external apparatus the data corresponding to the identification information inputted in the input step;
an image forming step that generates image data based on the data obtained in the obtaining step; and
a control step of controlling such that the data obtained in the obtaining step or the image data generated in the image forming step is stored in designated one of the groups.

14. An image processing device that obtains from an external device data designated by designation information and prints based on the data, the image processing device comprising:
a setting module that sets as to whether the designation information is to be stored or the data designated by the designation information is to be stored;
a determination module that determines as to whether a setting is made to store the designation information or a setting is made to store the data designated by the designation information;
a storage module that stores the designation information when a determination is made that the setting to store the designation information is made, and obtains and stores the data designated by the designation information when a determination is made that the setting to store the data designated by the designation information is made.

15. An image processing device according to claim 17, wherein the setting module sets as to whether the designation information is to be stored or the data designated by the designation information is to be stored for each domain.

16. An image processing device according to claim 17, further comprising an obtaining module that obtains print data, and a designation information determination module that determines as to whether the print data obtained includes the designation information,
wherein the storage module stores the designation information when a determination is made that the setting to store the designation information is made, and obtains and stores the data designated by the designation information when a determination is made that the setting to store the data designated by the designation information is made.

17. An image processing method that obtains from an external device data designated by designation information and prints based on the data, the image processing method comprising:
a setting step of setting as to whether the designation information is to be stored or the data designated by the designation information is to be stored;
a determination step of determining as to whether a setting is made to store the designation information or a setting is made to store the data designated by the designation information;
a storage step of storing the designation information when a determination is made that the setting to store the designation information is made, and obtaining and storing the data designated by the designation information when a determination is made that the setting to store the data designated by the designation information is made.
